(19) United States
(12) Patent Application Publication
(10) Pub. No.: US 2009/0078141 A1
(43) Pub. Date: Mar. 26, 2009

(54) Method of Performing Transfer Printing on Sheets of Paper

(75) Inventors: Toshio YAMASHITA, Kanazawa (JP); Takahiko NAKAMURA, Fuchu (JP)

Correspondence Address: THE WEBB LAW FIRM, P.C., 700 KOPPERS BUILDING, 436 SEVENTH AVENUE, PITTSBURGH, PA, 15219, US

(73) Assignee: Ryobi Ltd., Hiroshima (JP)

(21) Appl. No.: 12/233,255

(22) Filed: Sep. 18, 2008

(30) Foreign Application Priority Data
Sep. 20, 2007 (JP) 2007-243810

(51) Int. Cl. B41F 7/02

(52) U.S. Cl. 101/492

(57) ABSTRACT

There is provided a method of performing transfer printing on sheets of papers capable of stopping a film from running while the film is kept apart from a cylinder and patterns of the film are not transferred onto the sheets, and of joining the film to the cylinder with the film and the cylinder matched in speed and phase at the resumption of running. While the cylinder is rotated at a specific speed, the film is on a first travel path and stopped from running. Before the film is moved from the first travel path to a second travel path to be joined to the cylinder, four steps are performed so that the running speed of the film is matched to the rotation speed of the cylinder, and the phase of marks provided on the film at equal intervals is matched to the phase of a gripper of the cylinder.

### CROSS REFERENCE TO RELATED APPLICATION

This application claims priority from Japanese Patent Application No. 2007-243810, which is incorporated herein by reference.

### BACKGROUND OF THE INVENTION

1. Field of the Invention

The present invention relates to a transfer section for sheets of paper that presses a transfer film onto printed sheets of paper to transfer thereon gold foil, embossed patterns, hologram patterns, and the like, thereby to increase added value of the printed surfaces, and more particularly, to a method of performing transfer printing on sheets of paper, capable of matching the speed and phase of the film to those of a sheet of paper before pressing the film.

2. Related Art

There is proposed a gloss finishing apparatus for providing added value to printed sheets of paper in the above-mentioned manner. The apparatus includes a varnishing unit that applies an ultraviolet curable resin varnish (also simply referred to as “a varnish”) onto the printed sheets of paper printed in a printing unit and a hologram forming unit that presses a transfer film onto the sheets of paper varnished in the varnishing unit to transfer patterns of the film thereon. The hologram forming unit is constructed by an impression cylinder that conveys sheets of paper, a pair of pressing rollers that press the film onto the sheets of paper on the impression cylinder, and an ultraviolet irradiating unit that cures the varnish while the pressing rollers are pressing the film onto a sheet of paper, in such a way that the pair of pressing rollers are brought close to and apart from the impression cylinder between a retracting position above the impression cylinder and a pressing position proximate to the impression cylinder. Thus, when hologram forming (surface treatment) is not performed, the pressing rollers are moved upward relative to the impression cylinder to be located at the retracting position (e.g., see Japanese Unexamined Patent Publication No. 2006-315229 (FIGS. 1 and 2)).

In the gloss finishing apparatus according to Japanese Unexamined Patent Publication No. 2006-815229, the film is separated from the impression cylinder when the patterns of the film are not transferred onto the sheets of paper as described above; however, even while the film is kept apart, the film is being run unnecessarily in synchronization with the printing press, which is disadvantageous in respect to the durability of the film as well as increase in running cost.

In addition, since the apparatus does not include means for matching the phase of the film to that of the impression cylinder, it is unable to match patterns of the films to specific positions on the sheets of paper, which renders the apparatus hard to use.

### SUMMARY OF THE INVENTION

In order to overcome the foregoing problems, it is an object of the present invention to provide a method of performing transfer printing on sheets of paper, capable not only of halting a film while the film is kept apart from a cylinder so as not to transfer patterns of the film onto the sheets of paper, but also of joining the film to the cylinder with the film and the cylinder matched in speed and phase at the resumption of running of the film.

The present invention provides a method of performing transfer printing on a sheet of paper using a printing press including a film running mechanism having a first travel path and a second travel path, the first travel path being apart from a cylinder, the second travel path being proximate to the cylinder, a transfer film being capable of running both on the first and second travel paths, patterns of the film being transferred onto the sheet by pressing the film that is being running along the second travel path onto the sheet conveyed while being gripped with a gripping jaw of the cylinder, the method including: while rotating the cylinder at a specific speed, locating the film on the first travel path to stop the film from running, performing a series of steps to match a running speed of the film to the rotation speed of the cylinder and to match a phase of marks provided at equal intervals on the film to a phase of the gripping jaw of the cylinder, and then causing the film from the first travel path to the second travel path to be joined to the cylinder, the series of steps including:

(a) choosing a particular mark out of the marks on the film while the film is held stopped from running on the first travel path;

(b) calculating a travel path length in the second travel path from a position of the particular mark to a contact starting point where the film meets the sheet of paper;

(c) calculating a time required for running the film just for the travel path length on the assumption that the film that is held stopped is run just for the travel path length along the first travel path under a predetermined acceleration condition for acceleration of the cylinder from its stopped state up to the specific speed and a condition for the specific speed after the acceleration; and

(d) causing the film to start running along the first travel path at a point in time where the gripping jaw locates at a position from which the gripping jaw is to reach the contact starting point after the time calculated in the step (c), to match the speed of the film to the specific speed of the cylinder within the time calculated in the step (c).

First, a particular mark is chosen out of the marks provided longitudinally on the film while the film is held stopped from running on the first travel path. Then, calculation is performed to obtain a travel path length from the position of the chosen particular mark to a contact starting point where the film meets the sheet in the second travel path. Then, calculation is performed to obtain a time required for running the film just for the calculated travel path length on the assumption that the film that is held stopped is run just for the travel path length along the first travel path under a predetermined acceleration condition for acceleration of the cylinder from its stopped state up to the specific speed and a condition for the specific speed after the acceleration. This time is substituted for a rotation time of the cylinder, namely, on the assumption that the gripper locates at a position from which the gripper is to reach the contact starting point after the time calculated in the step (c), the film is caused to start running at that point in time along the first travel path, so as to match the speed of the film to the specific speed of the cylinder within the time calculated in the step (c). In this manner, the running speed of the film can be matched to the rotation speed of the cylinder, and the phase of the particular mark on the film can be matched to the phase of the gripper. After that, the film is brought proximate to the cylinder and is run along the second travel path, so that the patterns of the film can be transferred at specific positions on the sheets.

Given that the film that is held stopped is run under the predetermined acceleration condition of the step (c), a mark locating downstream of the aforesaid mark in a running direction may be chosen in the step (a), in a case where the travel path length is equal to or shorter than a travel distance to be reached when the predetermined acceleration is completed.

Since the running speed of the film can be matched to the rotation speed of the cylinder and besides the marks provided on the film at equal intervals can be matched in phase to the gripper of the cylinder, before the film is moved from the first travel path to the second travel path to be joined to the cylinder, it is possible not only to hold the film stopped where the transfer printing is not performed, but also to reliably transfer the patterns on the film at specific positions on the sheets of paper where the transfer printing is resumed or the printing press is activated to perform transfer printing. Thus, there can be provided a method of performing transfer printing on sheets of paper that is advantageous from the viewpoint of durability and running costs as well as usability.

On the assumption that the film that is held stopped is run under the predetermined acceleration condition of the step (c), a mark that locates downstream of the aforesaid mark in the running direction is chosen in the step (a), if the travel path length is equal to or shorter than the travel distance to be reached when the predetermined acceleration is completed; in this case, the film can be prevented from actually traveling the travel distance within which the film and the cylinder cannot be matched in speed and phase, so that efficient running control can be performed.

### BRIEF DESCRIPTION OF THE DRAWINGS

The above, and other objects, features and advantages of the present invention will become apparent from the detailed description thereof in conjunction with the accompanying drawings wherein.

FIG. 1 is a schematic side view of a sheet-fed printing press;

FIG. 2 is a side view of a transfer device;

FIG. 3 is an explanatory view showing a travel path from the position of a particular mark to a contact starting point where a film meets a sheet of paper;

FIG. 4 is a graph showing a relationship between the running speed and required time therefor, of the film;

FIG. 5 is a plan view of the film; and

FIG. 6 is a control block diagram.

### DESCRIPTION OF THE PREFERRED EMBODIMENTS

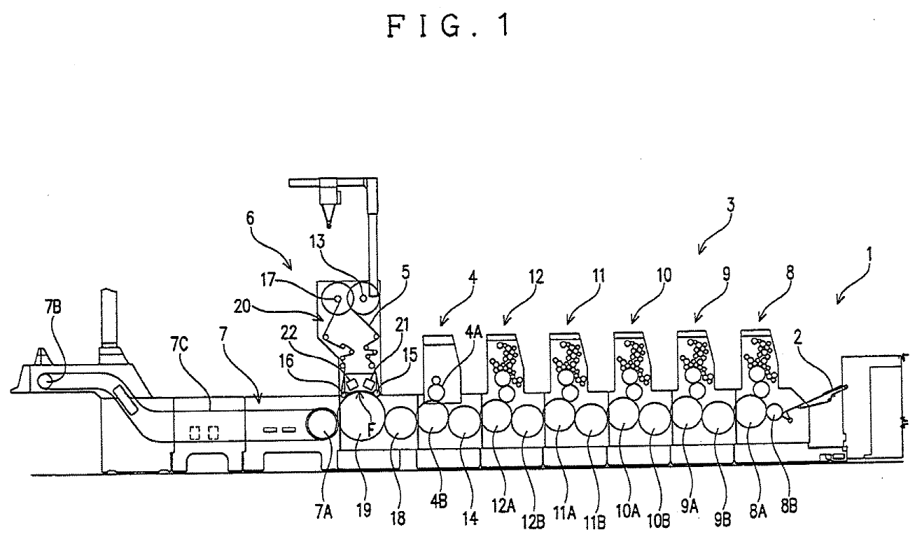

FIG. 1 shows an example of a printing press incorporating a transfer device 6 capable of treating the printed surfaces of printed sheets of paper by varnishing and gloss-finishing the printed surfaces with a resin varnish and transferring thereon gold foil, embossed patterns, hologram patterns, and the like. This printing press includes a sheet feeder section 1, a printer section 3, a varnish applicator section 4, a transfer section F, and a sheet discharge section 7. The sheet feeder section 1 feeds sheets of paper 2 one sheet at a time by means of a feeder device, a sheet separator device, and the like from a sheet stack table. The printer section 3 performs five-color printing on the sheets 2 fed from the sheet feeder section 1. The varnish applicator section 4 applies (coats) an ultraviolet curable resin varnish (also simply referred to as “a varnish”) onto the sheets 2 that have been printed in the printer section 3. The transfer section F presses a transfer film 5 made of a stretchable material with restoring force (e.g., polyethylene terephthalate, so-called PET; other materials may also be used), onto the ultraviolet curable resin varnish over the sheets 2 that have been applied with the ultraviolet curable resin varnish at the varnish applicator section 4, thereby treating the surfaces of the sheets 2. The sheet discharge section 7 discharges the sheets 2 whose surfaces have been treated at the transfer section F. Although the printer section 3 includes five printing units 8, 9, 10, 11, and 12 so that five-color printing can be performed in the present embodiment, the printer section may be one capable of printing other colors than five colors, such as a single color or more than one colors. In addition, while the sheet discharge section 7 is constructed of a chain conveyor device with grippers, the printing press may not include the sheet discharge section 7, and the specific structure of each section constituting the printing press is not limited to that shown in the figure. Also, the transfer device 6 may be built in the printing press to be used therein, whilst the transfer device 6 may not be built in the printing press and may be used as a single independent unit.

In the case of attaching gold foil to the printed surfaces, a foil applicator called a toiler is used to press printed material, so that gold foil is peeled off from a substrate onto a portion with an adhesive material (or may be varnish) of the printed material attached thereto. The printed surfaces may also be applied with something other than gold foil.

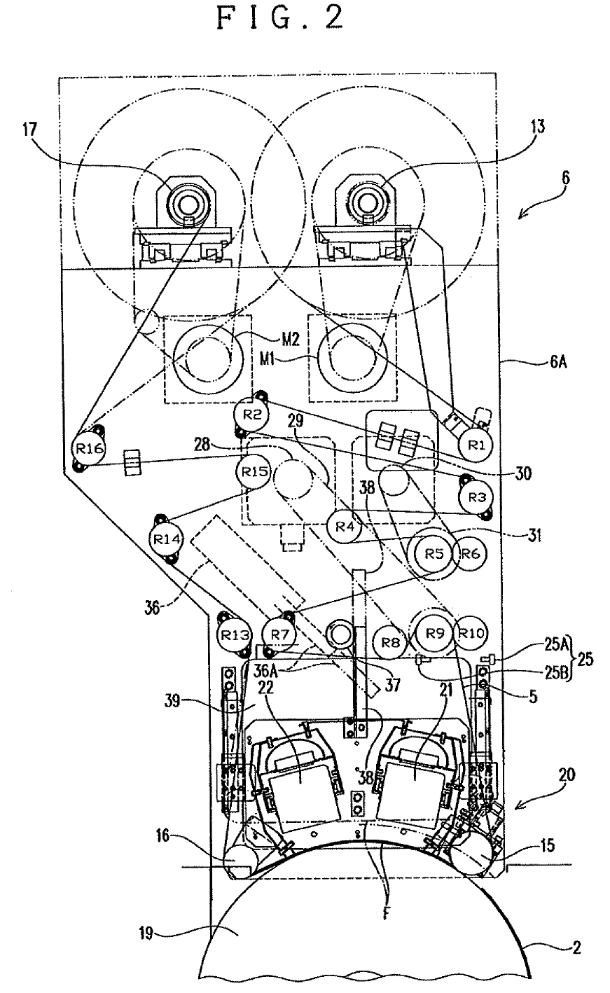

The printing units 8 to 12 include, respectively, printing impression cylinders 8A to 12A as well as delivery cylinders 8B to 12B on the respective upstream sides of the printing impression cylinders 8A to 12A in a conveying direction, for delivering sheets 2 to the printing impression cylinders. The delivery cylinder 8B that has a smaller diameter and locates at the leading end in the conveying direction out of the delivery cylinders 8B to 12B is also referred to as a sheet feeder cylinder, and this delivery cylinder 8B, together with the feeder device, sheet separator device, and the like, constitutes the sheet feeder section 1. Although not shown in the figure, each of the impression cylinders 8A to 12A and the delivery cylinders 9B to 12B is provided with grippers, each having a jaw block and a gripping jaw to grip a fed sheet 2, at two positions (although only one position is shown in FIG. 2, one gripper may be provided at a single position or more than two grippers may be provided at more than two positions) in a circumferential direction. Although not shown, the delivery cylinder 8B of a smaller diameter is provided with a gripper having a jaw block and a gripping jaw to grip a sheet 2, at a single position in the circumferential direction. Also, the varnish applicator section 4 includes a varnishing cylinder 4A from which the ultraviolet curable resin varnish is supplied and an impression cylinder 4B that is located opposite to the varnishing cylinder 4A and coats the ultraviolet curable resin varnish over the printed sheets 2.

A delivery cylinder 14 is provided to deliver sheets 2 to the impression cylinder 4B. Although not shown, each of these cylinders 14 and 14B is also provided with grippers, each having a jaw block and a gripping jaw to grip a fed sheet 2, at two positions (one gripper may also be provided at a single position or more than two grippers may also be provided at more than two positions) in the circumferential direction, as with the above cylinders.

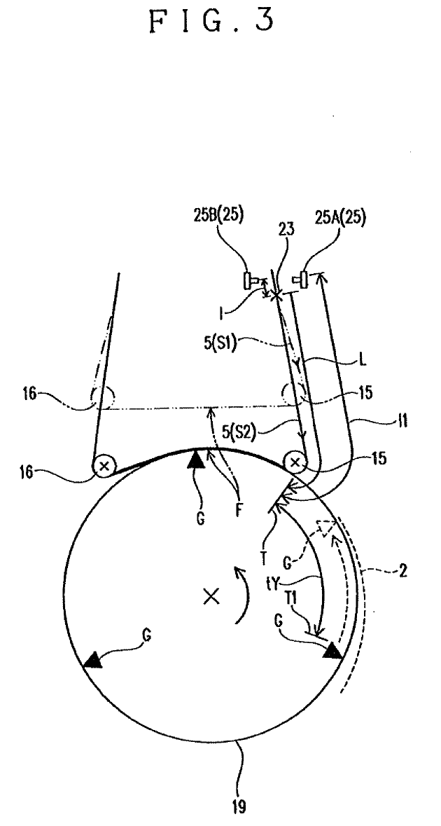

As shown in FIGS. 1 and 2, the transfer device 6 includes an impression cylinder 19 and a film transfer mechanism 20. The impression cylinder 19 receives sheets 2 from a delivery cylinder 18 that is provided to receive the sheets 2 from the impression cylinder 4B. The film transfer mechanism 20 presses the film 5 onto the sheets 2 on the impression cylinder 19 to perform transfer printing thereon. The film transfer mechanism 20 is a processing means for processing sheets 2 and this film transfer mechanism 20 presses the film 5 onto the sheets 2 to transfer gold foil, embossed patterns, hologram patterns, and the like from the film 5 onto the sheets 2 while utilizing, as an adhesive agent, the ultraviolet curable resin varnish that has been applied at the varnish applicator section 4. The film 5 is pressed onto the ultraviolet curable resin varnish over the sheets 2, so that the surfaces applied with the ultraviolet curable resin varnish can be smoothened and the surfaces are made even glossier. Then, ultraviolet irradiating lamps 21 and 22 (may be one or more than two) irradiate ultraviolet rays from above to the pressed film 5 to cure the ultraviolet curable resin varnish. The delivery cylinder 18 is also provided with grippers for gripping sheets 2 at two positions (one gripper may be provided at a single position or more than two grippers may be provided at more than two positions) in the circumferential direction, as with the above cylinders. The impression cylinder 19 is a so-called triple-diameter cylinder that has a larger diameter than the delivery cylinder 18 and is provided with grippers at three positions (FIG. 3 shows the positions of gripping jaws G of the three grippers, but one gripping jaw may be provided at a single gripper, or alternatively two gripping jaws at two grippers or more than three gripping jaws at more than three grippers) in the circumferential direction, as with the above cylinders; therefore, the delivery cylinder 18 rotates 1.5 times while the impression cylinder 19 rotates a single time, whereby a sheet 2 can be passed to a gripping jaw G on the impression cylinder 19 from a gripping jaw on the delivery cylinder 18 as described above. FIG. 3 shows a state in which a gripper G on the lower right side moves upward and a sheet 2 is passed to the gripper G (shown with a dashed line) on the impression cylinder 19. The impression cylinder 19 having a larger diameter (triple-diameter cylinder) than the other cylinders advantageously ensures a larger drying zone for the irradiation of ultraviolet rays as well as a longer distance from the varnish applicator section 4, but the impression cylinder 19 may have the same diameter as the other cylinders.

As shown in FIGS. 1 and 2, the transfer device 6 includes a feed roll 13, two (may be one or more than two) pressing rollers 15 and 16, and a windup roll 17. The feed roll 13 is capable of winding up the film 5 as well as feeding the film 5. The pressing rollers 15 and 16 press the film 5 fed from the feed roll 13 onto the sheets (printed sheet) 2 on the impression cylinder 19. The windup roll 17 winds up the film 5, which is peeled off from the printed sheets after being pressed by the pressing rollers 15 and 16. In FIG. 2, between the feed roll 13 and the pressing roller 15 on the upstream side in the conveying direction out of the two pressing rollers 15 and 16 provided are film guiding rollers R1 to R10, among which the rollers R9 and R5 are drive rollers. Between the pressing roller 16 on the downstream side in the conveying direction out of the two pressing rollers 15 and 16 and the windup roll 17 provided are film guiding rollers R13 to R16. The roller R4 is a tension roller that is provided on the feed side to apply predetermined tension. The roller R15 is a tension roller that is provided on the windup side to apply predetermined tension. The pressing roller 16 on the downstream side in the conveying direction is disposed at a position that is spaced upward from the impression cylinder 19 a set distance, because the film 5 can thereby be separated (peeled off) smoothly from the sheets 2; however, the pressing roller 16 may pressingly contact the impression cylinder 19. The feed roll 13 is rotatably driven with the power of an electric motor M1 for the feed roll, and the windup roll 17 is rotatably driven with the power of an electric motor M2 for the windup roll. While a total of four electric motors, i.e., the two electric motors M1 and M2 and two electric motors 28 and 30 for rotatably driving the drive rollers R9 and R5, are basically operated in synchronization with one another, these motors are configured such that the rotation speeds thereof, which sometimes cause loosening or excessive tension in the film 5, are controlled so as to favorably eliminate such loosening or excessive tension. In addition to the above configuration in which the film 5 fed from the feed roll 13 is wound onto the windup roll 17, rolls may be so disposed as to endlessly convey the film 5. The four electric motors M1, M2, 28, and 30 constitute a film running mechanism that is capable of running the film 5 along any of a first travel path S1 and a second travel path S2 to be described later. The power from the electric motors 28 and 30 is transmitted to the drive rollers R9 and R5 through timing belts 29 and 31, respectively.

A driving part is provided to move the transfer section F away from and towards the impression cylinder 19. As shown in FIG. 2, an extension rod 36A of an air cylinder 36 is provided with teeth that engage with a gear 37 that is rotatably fitted to a casing 6A of the transfer device 6, and the gear 37 is rotated by the elongation and contraction of the extension rod 36A to produce torque, which torque is then converted to vertically moving force by teeth provided on a rack 38; the lower end of the rack 38 is coupled to the upper end of a support member 39 at an approximate center in the sheet-conveying direction, which support member 39 is installed with the pressing rollers 15 and 16 and the like, so that a driving part is constructed. Accordingly, in a case where the surface treatment, i.e., transfer of the patterns of the film 5, is not performed, or when the power is turned off at the completion of the printing operation, the extension rod 36A of the air cylinder 36 is extended to an upward position shown with a chain double-dashed line in FIG. 2, thereby rotating the gear 37 counterclockwise to cause the rack 38 to move to an upward position shown with a chain double-dashed line and to raise the support member 39 to an upward position. In this manner the transfer section F (the pressing rollers 15 and 16 as well as the film 5 carried between the pressing rollers 15 and 16) can be moved away from the impression cylinder 19. In order to lower the transfer section F, the extension rod 36A of the air cylinder 36 is contracted to a position shown with a dashed line in FIG. 2, so that the transfer section F (the pressing rollers 15 and 16 as well as the film 5 carried between the pressing rollers 15 and 16) can be moved close to the impression cylinder 19 (as shown with a solid line in FIG. 2). Although the transfer section F is moved vertically in the present embodiment, it is possible to freely change the separating or approaching direction of the transfer section F relative to the cylinder 19. In the example shown in the figure, the transfer section F that locates at the lower end of the transfer device 6 is moved away from the impression cylinder 19, and this configuration is advantageous in downsizing the structure for separating movement; alternatively, however, the entire transfer device 6 may be designed to be moved away from the impression cylinder 19.

As shown in FIGS. 2 and 3, the film running mechanism, which is capable of running the film 5 both along the first travel path S1 (shown with a chain double-dashed line) apart from the cylinder 19 and the second travel path S2 (shown with a solid line) proximate to the cylinder 19, is comprised of the four electric motors M1, M2, 28, and 30, and by actuating these four electric motors M1, M2, 28, and 30, the film 5 can be run both in the upward position and the downward position of the transfer section F. Specifically, when the transfer section F is moved from the downward position to the upward position, the four electric motors M1, M2, 28, and 30 are driven and controlled so as not to loosen the film 5, whereas when the transfer section F is moved from the upward position to the downward position, the four electric motors M1, M2, 28, and 30 are driven and controlled so that excessive tension will not be applied to the film 5. It should be noted that the four electric motors M1, M2, 28, and 30 are driven in synchronization with one another until the transfer section F locates at the upward position where the transfer section F is released from a state of being joined to the cylinder 19, and thereafter the drive of the motors is stopped.

The present invention is configured such that before the transfer section F is lowered and joined to the cylinder 19, the running speed of the film 5 is matched to the rotation speed of the cylinder 19, and the phase of marks 23 provided at equal intervals on the film 5 is also matched to that of the gripping jaws G on the cylinder 19. The configuration is described below.

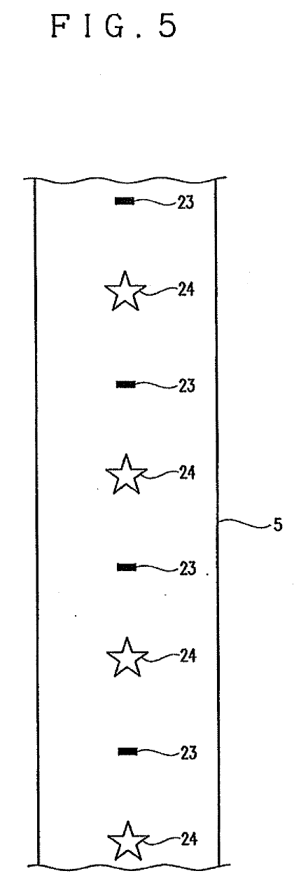

The marks 23 are first described. As shown in FIG. 5, the marks 23 are provided coated with black color (any color may be used as long as it is detectable) on the film 5 made of a thin, transparent and colorless sheet at predetermined intervals; however, patterns 24 that are lined longitudinally on the shown film 5 and provided between the marks 23 may be used as the marks, or in the case where, e.g., the film is formed of a number of linked films, the linked portions (translucent portions) may be used as the marks. Also, although the shown patterns 24 are all identical to one another, the patterns may be different from one another. Further, the patterns may be provided over the entire area of the film, in addition to the structure in which the patterns are provided only on portions among the marks of the film.

The cylinder 19 is rotated on activation of the printing press in synchronization therewith, and when a specific speed (idling speed) is attained, the cylinder 19 is rotated at the specific speed until printing is started. Meanwhile, the film 5 is stopped from running while being located on the first travel path S1, and the film 5 is moved from the first travel path S1 to the second travel path S2 to be joined to the cylinder 19, where the patterns of the film 5 are transferred onto a sheet 2.

In the present description, the step of matching the phase of the marks 23 to that of the gripping jaws G of the cylinder 19 includes four steps of (a) to (d), and the steps are conducted in order. These four steps are specified as follows:

(a) The step of choosing a particular mark 23 on the film 5 while the film 5 is held stopped from running on the first travel path S1.

This step is carried out, as shown in FIG. 3, by holding the position of a mark 23 at the moment when the mark 23 passes through a sensor 25 to be described later while the film 5 is being raised to the upward position to be stopped there, in which way the mark 23 is chosen. Actually, the sensor 25 first detects a mark 23, a rotary encoder (not shown) capable of reading the number of rotation of the drive roller R5 calculates the length over which the drive roller R5 has delivered the film 5 as from the detection of the mark 23 by the sensor 25, and the length from the sensor 25 to the mark 23 is held or stored.

(b) The step of calculating a travel path length L from the held or stored position of the particular mark 23 to a contact starting point T where the film 5 meets the sheet 2 in the second travel path S2.

As shown in FIG. 3, there is a difference between the attitude of the film 5 along the first travel path S1 from the drive roller R9 (see FIG. 2) to the pressing roller 15 and the attitude of the film 5 along the second travel path S2 from the drive roller R9 (see FIG. 2) to the pressing roller 15; therefore, it is seemingly difficult to accurately calculate the travel path length L from the position of the mark 23 to the contact starting point T where the film 5 meets the sheet 2 in the second travel path S2, based on the position of the particular mark 23 on the film 5 in the first travel path S1, because the position of the particular mark 23 on the film 5 in the first travel path S1 is different from the position of the mark 23 in the second travel path S2. The delivered length, however of the drive roller R9 as from the detection of the mark 23 by the sensor 25 is the same in either of the travel path S1 or S2, and hence it is possible to obtain an accurate value without error of the travel path length L in the second travel path S2 up to the contact starting point T where the film 5 meets the sheet 2, based on the position of the particular mark 23 calculated for the first travel path S1. Moreover, for instance, the position of the particular mark 23 on the film 5 in the first travel path S1 is calculated, then the transfer section F is lowered with the film 5 stopped from running, calculation is performed for the travel path length L from the particular mark 23 at that lowered position to the contact starting point T, which calculation is repeated a number of times, and the calculated values are formed into a table for use. In this manner, just extracting data from the table based on the position of the particular mark 23 on the film 5 in the first travel path S1 provides an accurate travel path length L up to the contact starting point T.

(c) The step of calculating a time tY required for running the film just for the travel path length L on the assumption that the film 5 that is held stopped is run just for the travel path length L along the first travel path S1 under a predetermined acceleration condition for acceleration of the cylinder 19 from its stopped state up to a specific speed and a condition for the specific speed after the acceleration.

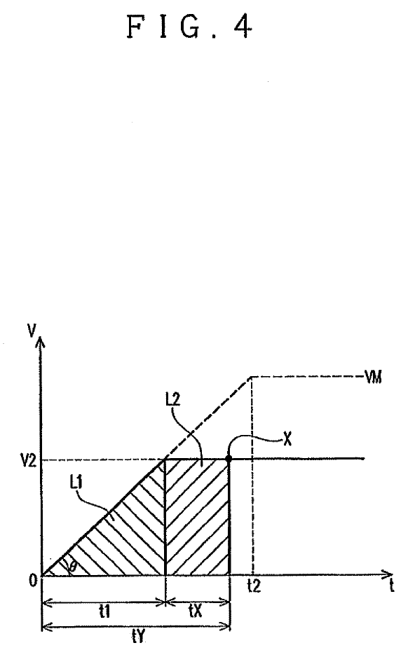

For instance, as shown in FIG. 4, assuming that the travel path length L is made up of an acceleration area L1 (the area enclosed in a triangle) where the speed is accelerated to a velocity V2 (an idling speed equal to the speed of the cylinder 19) at a constant acceleration and a constant speed area L2 (the area enclosed in a rectangle) where the velocity V2 is kept constant after the acceleration, the time tY required for running the film just the for travel path length L is calculated. That is, a distance tX in the constant speed area L2 is calculated so that the running speed of the film 5 can be matched to that of the cylinder 19 in the acceleration area L1, and that the phase of the film 5 can be matched to that of the cylinder 19 in the constant speed area L2. Since a distance t1 shown in FIG. 4 is a known value that is set in advance, and the travel path length and the idling speed are also known values, the distance tX can be calculated based on these values.

The calculated tX and t1 makes tY. In the present embodiment, the angle θ gradient) of the uniform acceleration, which is shown as the acceleration condition, can be freely altered, and the acceleration may be changed stepwise. Alternatively, the acceleration may be changed in a curved pattern, and any acceleration condition may be used until the idling speed is attained.

(d) The step of causing the film 5 to start running along the first travel path S1 at the point in time where the gripping jaw G locates at a position T1 from which the gripper G is to reach the contact starting point T after the time calculated in the step (c), so as to match the speed of the film 5 to the specific speed of the cylinder 19 within the time tY calculated in the step (c).

The above-described four steps are carried out in turn to match the speed and phase of the film 5 to those of the cylinder 19. When the film 5 and the cylinder 19 are matched in speed and phase, the film 5 is lowered and joined to the cylinder 19 to transfer the patterns 24 of the film 5 at predetermined positions on the sheets 2.

As a position detecting part that detects the position of a mark 23 in choosing the particular mark 23 in the step (a), an optoelectronic sensor 25 including a photo-emitting part 25A and a photo-receiving part 25B is used; however, any other device may be used. The sensor 25 is disposed, with the photo-emitting surface and the photo-receiving surface located opposite to each other with the film 5 interposed therebetween, at a position (a position on the film feed side spaced a set distance from the point where the film transfer is started) directly downstream the drive roller R9, so as to choose as the particular mark 23 a mark 23 that passes the optoelectronic sensor 25 lastly before the film 5 is stopped from running. The rate (angle) of rotation of the drive roller R9 as from the detection by the optoelectronic sensor 25 is detected using a potentiometer or the like, and the travel distance l of the mark 23 from the optoelectronic sensor 25 is subtracted from a previously stored distance l1 from the contact starting point T to the optoelectronic sensor 25, thereby calculating the distance L from the contact starting point T to the position of the mark 23 detected by the optoelectronic sensor 25.

On the assumption that the film 5 that is held stopped is run under the predetermined acceleration condition of the step (c), if the travel path length L is equal to or shorter than the travel distance to be reached when the predetermined acceleration is completed, a mark 23 that locates downstream of the mark 23 in the running direction is chosen in the step (a), so that the travel path length L is made longer than the travel distance up to the predetermined acceleration completion point to prevent unnecessary running control of the film 5. In a case where the travel path length L is equal to or shorter than the travel distance to be reached when the predetermined acceleration is completed even when the mark 23 downstream of the chosen mark 23 in the running direction is re-chosen, then a mark 23 that locates further downward in the running direction is chosen. The mark to be chosen may be a last mark out of the marks 23 detected by the optoelectronic sensor 25 before the film 5 is stopped; alternatively, the mark may be a first mark 23 that locates at the leading end in the running direction out of the marks 23 that locate downward of that mark 23 in the running direction, or may be a second mark 23 that locates downward of the first mark 23.

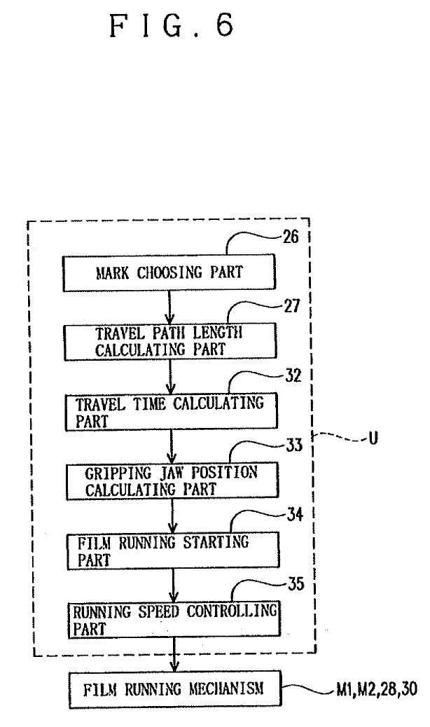

The above four steps are automatically carried out by various kinds of parts included in a controller U, which is described below with reference to FIG. 6.

That is, the step of choosing a particular mark 23 in (a) is carried out by a mark choosing part 26, the step of calculating a travel path length from the position of the chosen mark 23 to a contact starting point T in (b) is carried out by a travel path length calculating part 27, and the step of calculating a time required for running the film for the travel path length in (c) and the step of causing the film 5 to start running in (d) are carried out by a gripping jaw position calculating part 33 that obtains the time and calculates a position T1 of a gripping jaw G, a film running starting part 34 that causes the film 5 to start running after the calculations and a running speed controlling part 35 that outputs drive control signals to the film running mechanisms M1, M2, 28, and 30 so as to control the running speed of the film 5 after the start of the running of the film. The calculating parts store in a memory of the controller a huge amount of data that has been calculated in advance, and a suitable piece is extracted from the stored data, which allows the processing time until the start of the running of the film to be shortened; however, arithmetic expressions may be held, and calculation may be performed each time data is inputted.

When a state in which the printing press is activated or is only performing printing operation and not the transfer operation with the film 5 stopped at the upward position transits to the transfer operation mode to carry out the transfer of the film 5, a particular mark 23 of the marks 23 on the film 5 is chosen, the position of the mark 23 that is held or stored at the time of stop of the film 5 is extracted, and a travel path length L in the second travel path S2 is extracted out of the tabled data, based on the position of the mark 23. A time required for running the film for the travel path length L is extracted from the data stored in advance, the position T1 of a gripping jaw G corresponding to that data is extracted from another data, and the fact that the gripping jaw G has located at that position T1 of the gripping jaw G is determined based on the detected information of the rotary encoder that detects the rotation angle of the cylinder 19. With the gripping jaw G locating at the position, the four electric motors M1, M2, 28, and 30 serving as the film running mechanism are driven to cause the film 5 to start running, thereby matching the running speed and phase of the film 5 to the rotation speed and phase of the cylinder 19. The film 5 may actually be run, as in the graph of FIG. 4 used for calculating the time required for running the film for the travel path length in the step (c), through the acceleration area L1 (although the acceleration is constant in the figure, any acceleration may be used as described earlier) to reach the constant speed area L2, but the film 5 may be run only through the acceleration area L1. That is, the film 5 may be run at a constant acceleration connecting X with the origin 0 in FIG. 4, or may be run in any line pattern (a plurality of straight lines, a polygonal line, or a curve) connecting X with the origin 0 without the constant speed area L2. Once the running speed and phase of the film 5 are matched to the rotation speed and phase of the cylinder 19, namely, once X of FIG. 4 is reached, the film 5 and the cylinder 19 can be matched in speed and phase at any given time the film 5 is lowered; therefore, the patterns of the film 5 can be repeatedly transferred while being matched to predetermined positions on the cylinder 19.

The sheet discharge section 7 includes a conveyor device for receiving the sheets 2 that have been processed in the processing devices and conveyed thereto, and conveying them to a predetermined position. The conveyor device is provided over a pair of right and left endless running chains 7C that are suspended between a pair of right and left sprockets 7A and 7B respectively. Each of the sprockets 7A and 7B is provided with grippers (although not shown, the basic structures thereof are the same as the above-described grippers) for gripping the sheets at both ends in the sheet-conveying direction (see FIG. 1).

This specification is by no means intended to restrict the present invention to the preferred embodiments set forth therein. Various modifications to the method of performing transfer printing, as described herein, may be made by those skilled in the art without departing from the spirit and scope of the present invention as defined in the appended claims.

What is claimed is:

1. A method of performing transfer printing on a sheet of paper using a printing press including a film running mechanism having a first travel path and a second travel path, the first travel path being apart from a cylinder, the second travel path being proximate to the cylinder, a transfer film being capable of running both on the first and second travel paths, patterns of the film being transferred onto the sheet by pressing the film that is being running along the second travel path onto the sheet conveyed while being gripped with a gripping jaw of the cylinder, the method including: while rotating the cylinder at a specific speed, locating the film on the first travel path to stop the film from running, performing a series of steps to match a running speed of the film to the rotation speed of the cylinder and to match a phase of marks provided at equal intervals on the film to a phase of the gripping jaw of the cylinder, and then causing the film from the first travel path to the second travel path to be joined to the cylinder, the series of steps including:
(a) choosing a particular mark out of the marks on the film while the film is held stopped from running on the first travel path;
(b) calculating a travel path length in the second travel path from a position of the particular mark to a contact starting point where the film meets the sheet of paper;
(c) calculating a time required for running the film just for the travel path length on the assumption that the film that is held stopped is run just for the travel path length along the first travel path under a predetermined acceleration condition for acceleration of the cylinder from its stopped state up to the specific speed and a condition for the specific speed after the acceleration; and
(d) causing the film to start running along the first travel path at a point in time where the gripping jaw locates at a position from which the gripping jaw is to reach the contact starting point after the time calculated in the step (c), to match the speed of the film to the specific speed of the cylinder within the time calculated in the step (c).

2. The method according to claim 1, wherein
given that the film that is held stopped is run under the predetermined acceleration condition of the step (c), a mark locating downstream of the aforesaid mark in a running direction may be chosen in the step (a), in a case where the travel path length is equal to or shorter than a travel distance to be reached when the predetermined acceleration is completed.
